(19) United States
(12) Patent Application Publication
(10) Pub. No.: US 2018/0117864 A1
(43) Pub. Date: May 3, 2018

(54) COLORED HARD CONTACT LENS PRINTING METHOD

(71) Applicant: HAPPY VISION CORP., Anyang-si (KR)

(72) Inventors: Na Jung PARK, Anyang-si (KR); Jung Soo PARK, Anyang-si (KR)

(73) Assignee: HAPPY VISION CORP., Anyang-si (KR)

(21) Appl. No.: 15/846,993

(22) Filed: Dec. 19, 2017

Related U.S. Application Data
(63) Continuation of application No. PCT/KR2016/010683, filed on Sep. 23, 2016.

(30) Foreign Application Priority Data
Oct. 21, 2015 (KR) 10-2015-0146870

(51) Int. Cl. B29D 11/00; B41M 1/26; B41M 3/00; B41M 7/00; G02C 7/04

(52) U.S. Cl. CPC B29D 11/00923; B29D 11/00038; G02C 7/046; B41M 3/003; B41M 7/0054; B41M 1/26

(57) ABSTRACT

A colored hard contact lens printing method for printing an iris design on the whole surface of a hard contact lens, the method includes: a preparation step of preparing a hard contact lens, a centering jig, and a composition for printing so as to print an iris design on the hard contact lens; a printing step of mounting the hard contact lens on the centering jig and printing the iris design by using the composition for printing; and a post-treatment step of post-treating the hard contact lens having the iris design printed thereon. Therefore, the present invention prints iris designs of various colors and patterns on the outer circumference of the front surface of the hard contact lens by using the composition for printing, thereby providing an effect of manufacturing a colored hard contact lens having iris designs of various colors and patterns on the front surface thereof.

### CROSS-REFERENCE

This application is a continuation application of international application PCT/KR2016/010683, filed on Sep. 23, 2016, now pending, which claims foreign priority from Korean Patent Application No. No. 10-2015-0146870, filed on Oct. 21, 2015 in the Korean Intellectual Property Office, the disclosure of each document is incorporated herein by reference in their entirety.

### TECHNICAL FIELD

The present invention relates to a colored hard contact lens printing method, and more particularly, a colored hard contact lens printing method for printing iris designs of various colors and patterns on the outer circumference of the front surface of a hard contact lens.

### BACKGROUND ART

In general, many people with poor vision or astigmatism use glasses or contact lenses. Contact lenses are uncomfortable to wear, but are widely used because they are not exposed. Contact lenses are classified into soft contact lenses, which are of a disposable or regularly replaceable type and are made of a soft material, and hard contact lenses, which are made of a hard material and can be used for long hours or a long time, based on the material that they are made of.

Against the backdrop of women's aesthetic pursuits and various successes in product development, contact lenses of various colors, which are not only for the purpose of vision correction, but are capable of offering cosmetic benefits, have been developed. In other words, even people with good vision often wear contact lenses with iris designs of various colors and patterns printed on the outer circumferences thereof to improve their appearances, that is, to change the color of their eyes to, for example, blue, or to make their eyes appear bigger.

In particular, as the world has become more and more globalized, the interactions between different races and between different cultures have increased, and the demand for colored contact lenses that can change the color of the eyes at will has steadily grown.

Colored contact lenses are classified into two categories. First, there are transparent colored contact lenses. The transparent colored contact lenses have been developed to emphasize transparency or block rays of light, rather than to change the apparent color of the irises. Accordingly, there is a limit in changing the color of the eyes to any desired color using the transparent colored contact lenses, and thus, the transparent colored contact lenses are generally used for identification purposes or for the purpose of blocking ultraviolet rays, rather than for cosmetic purposes.

Second, there are opaque colored contact lenses capable of changing the apparent color of the irises to another color. However, since the particle size of an opaque pigment used in the opaque colored contact lenses is generally larger than the pore size of soft contact lenses, it is difficult to directly color contact lenses with the pigment.

Such conventional colored contact lenses have pupil portions that make the pupils of the eyes transparent and also have portions that are formed to be larger than the pupils for adding predetermined colors or patterns, and can thus make the eyes appear bigger or have a different color from their original color.

That is, a colored contact lens has a lens portion, which is transparently formed in the center of the contact lens so as not to block the pupil, and an expanded portion, which is formed on the outside of the lens portion to partially overlap with the iris and is combined with a predetermined pattern or color to appear as a natural iris.

The expanded portion has a predetermined pattern or is dyed with a pigment such as a black pigment. Thus, the expanded portion can make the eye of a wearer appear bigger or change the color of the eye of the wearer.

That is, these colored contact lenses are generally used for cosmetic purposes, rather than for vision correction purposes, and are for making the eyes appear bigger and more colorful so as for the eyes to appear more beautiful.

Conventionally, iris designs can be formed only on soft contact lenses and are difficult to be formed on hard contact lenses. Thus, colored soft contact lenses have been widely used. However, it is complicated and difficult to print iris designs on soft contact lenses, and thus, the manufacturing cost of colored soft contact lenses increases.

### PRIOR ART DOCUMENT

### Patent Literature

(Patent Literature 1) Korean Utility Model No. 20-0386696 (Jun. 16, 2005)

### DISCLOSURE

### Technical Problems

To address the aforementioned problems, exemplary embodiments of the present invention provide a colored hard contact lens printing method capable of fabricating a colored hard contact lens having iris designs of various colors and patterns on the front surface thereof. Exemplary embodiments of the present invention also provide a colored hard contact lens printing method capable of processing a hard contact lens to have a size suited for a user, fabricating a centering jig to have a size suited for the hard contact lens, and preparing a composition capable of maintaining its adherence on the hard contact lens.

Exemplary embodiments of the present invention also provide a colored hard contact lens printing method capable of reducing the amount of time that it takes to perform centering between a hard contact lens and a centering jig, and at the same time, improving the bonding between the hard contact lens and the centering jig.

Exemplary embodiments of the present invention also provide a colored hard contact lens printing method capable of improving the adherence of an iris design on a hard contact lens, which is formed into a predetermined shape, so as for the iris design to be properly adhered on the hard contact lens and not to be deformed on the hard contact lens, unlike on a soft contact lens where it would be easily deformable.

Exemplary embodiments of the present invention also provide a colored hard contact lens printing method capable of printing iris designs of various colors and patterns on a hard contact lens with ease.

Exemplary embodiments of the present invention also provide a colored hard contact lens printing method capable of realizing iris designs of various colors and patterns on the outer circumference of the front surface of a hard contact lens.

Exemplary embodiments of the present invention also provide a colored hard contact lens printing method capable of improving the adherence of an iris design printed on the outer circumference of the front surface of a hard contact lens and preventing the discoloration of the iris design so as to improving the durability of the iris design.

Exemplary embodiments of the present invention also provide a colored hard contact lens printing method capable of improving the adherence of an iris design printed on the outer circumference of the front surface of a hard contact lens.

Exemplary embodiments of the present invention also provide a colored hard contact lens printing method capable of preventing damage to an iris design, and at the same time, extending the retention period of the iris design.

### Technical Solutions

According to an aspect of the present invention, a colored hard contact lens printing method for printing an iris design on a front surface of a hard contact lens includes: a preparation step of preparing a hard contact lens, a centering jig, and a composition for printing so as print an iris design on the hard contact lens; a printing step of mounting the hard contact lens on the centering jig and printing the iris design by using the composition for printing; and a post-treatment step of post-treating the hard contact lens having the iris design printed thereon. The preparation step may include: a lens processing step of processing a hard contact lens; a jig fabrication step of fabricating a centering jig to have a size suited for the processed hard contact lens; and a composition mixing step of mixing a composition for printing an iris pattern on a hard contact lens.

The jig fabrication step may include fabricating a centering jig in accordance with an inner curvature radius of a hard contact lens, a size of an edge portion of the hard contact lens, and a diameter of the hard contact lens. The composition mixing step may include mixing an oligomer, which has fluororesin as its main ingredient, and a pigment.

The printing step may include feeding the composition for printing, contained in a cup mounted in a printing apparatus, to a copper plate and printing the fed composition on the hard contact lens mounted on a centering jig.

The cup may contain the composition for printing therein, and a number of cups determined by a number of color patterns of the iris design may be mounted in the printing apparatus. A size of the copper plate may be determined by a size of the hard contact lens, and a number of copper plates determined by a number of color patterns of the iris design may be mounted in the printing apparatus.

The post-treatment step may include: a coating step of coating the hard contact lens with the iris design printed thereon; and a curing step of thermally curing the coated hard contact lens. The coating step may include applying a coating liquid onto the front surface of the hard contact lens so as for the iris design to remain its printed state on the front surface of the hard contact lens. The curing step may include thermally curing the hard contact lens at a temperature of 35 to 45□ for 20 to 28 hours.

### Advantageous Effects

As discussed above, a hard contact lens having iris designs of various colors and patterns can be fabricated by printing iris designs of various colors and patterns on the outer circumference of the front surface of a hard contact lens with the use of a composition for printing.

Also, in a preparation step, since a hard contact lens is processed, a centering jig is fabricated, and a composition for printing is mixed, a hard contact lens can be processed to have a size suited for a user, a centering jig can be fabricated to have a size suited for the hard contact lens, and a composition capable of maintaining its adherence on the hard contact lens can be prepared.

Also, in a jig fabrication step, since a centering jig is fabricated in accordance with the inner curvature radius of a hard contact lens, the size of an edge portion of the hard contact lens, and the diameter of the hard contact lens, the amount of time that it takes to perform centering between the hard contact lens and the centering jig can be reduced, and at the same time, the bonding between the hard contact lens and the centering jig can be improved.

Also, in a composition mixing step, since an oligomer, which has fluororesin as its main ingredient, and a pigment are mixed. As a result, the adherence of an iris design on a hard contact lens, which is formed into a predetermined shape, can be improved so that the iris design can be properly adhered on the hard contact lens and cannot be deformed on the hard contact lens, unlike on a soft contact lens where it would be easily deformable.

Also, in a printing step, since a composition for printing contained in a cup mounted in a printing apparatus is fed to a copper plate and is then printed on a hard contact lens, iris designs of various colors and patterns can be printed on the hard contact lens with ease.

Also, since a composition for printing is contained in each cup and a number of cups determined by the number of color patterns of an iris design are mounted in a printing apparatus, iris designs of various colors and patterns can be realized on the outer circumference of the front surface of a hard contact lens.

Also, since the size of each copper plate is determined by the size of each hard contact lens and a number of copper plates determined by the number of color patterns of an iris design are mounted in a printing apparatus, iris designs of various colors and patterns can be realized on the outer circumference of the front surface of a hard contact lens.

Also, in a post-treatment step, since a hard contact lens with an iris design printed thereon is coated and is then thermally cured, the adherence of an iris design printed on the outer circumference of the front surface of the hard contact lens can be improved, and the discoloration of the iris design can be prevented so as to the durability of the iris design.

Also, in a coating step, since a coating liquid is applied onto the front surface of a hard contact lens so as for an iris design printed on the outer circumference of the front surface of the hard contact lens to remain its printed state, damage to the iris design can be prevented, and at the same time, the retention period of the iris design can be extended.

Also, in a curing step, since a hard contact lens with an iris design printed on the outer circumference of the front surface thereof is thermally cured at a predetermined temperature, the adherence of the iris design printed on the outer circumference of the front surface of the hard contact lens can be improved.

### BRIEF DESCRIPTION OF DRAWINGS

FIG. 1 is a flowchart illustrating a colored hard contact lens printing method according to an exemplary embodiment of the present invention.

FIG. 2 is a view illustrating various parts of a colored hard contact lens according to an exemplary embodiment of the present invention.

FIG. 3 is a view illustrating a printing apparatus for use in the colored hard contact lens printing method according to an exemplary embodiment of the present invention.

### BEST MODES FOR CARRYING OUT THE INVENTION

Exemplary embodiments of the present invention will hereinafter be described with reference to the accompanying drawings.

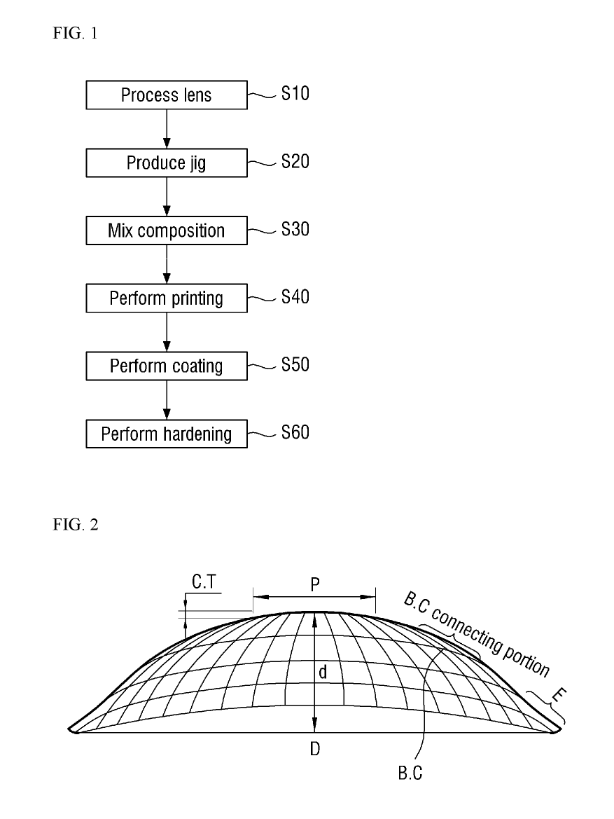

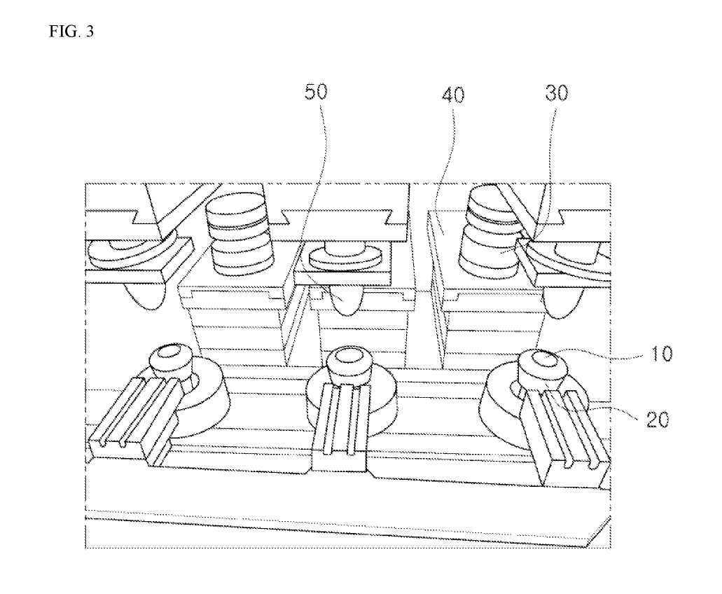

FIG. 1 is a flowchart illustrating a colored hard contact lens printing method according to an exemplary embodiment of the present invention, FIG. 2 is a view illustrating various parts of a colored hard contact lens according to an exemplary embodiment of the present invention, and FIG. 3 is a view illustrating a printing apparatus for use in the colored hard contact lens printing method according to an exemplary embodiment of the present invention.

Referring to FIGS. 1 through 3, the colored hard contact lens printing method according to an exemplary embodiment of the present invention is a colored hard contact lens printing method for printing iris designs of various colors and patterns on the outer circumference of the front surface of a hard contact lens and includes a preparation step, a printing step (S40), and a post-treatment step, the preparation step includes a lens processing step (S10), a jig fabrication step (S20), and a composition mixing step (S30), and the post-treatment step includes a coating step (S50) and a curing step (S50).

The preparation step, which is the step of preparing a hard contact lens, a centering jig, and a composition for printing so as to print iris designs of various colors and patterns on the outer circumference of the front surface of the hard contact lens, includes the lens processing step (S10), the jig fabrication step (S20), and the composition mixing step (S30).

In the lens processing step (S10), which is the step of processing a hard contact lens, the front and rear surfaces of a hard contact lens 10 are subjected to a turning operation, and an edge portion E of the hard contact lens 10 is subjected to a grinding operation.

Accordingly, the hard contact lens 10 is processed to set six variables such as an inner curvature radius B.C, power P, lens diameter D, center thickness C.T, lens depth d, the design of the edge portion E, and the design of an inner curvature radius (B.C) connecting portion.

In the jig fabrication step (S20), which is the step of fabricating a centering jig 20 so as to match the sizes of various parts of the hard contact lens 10 processed in the lens processing step (S10), the centering jig 20 is fabricated in accordance with the inner curvature radius B.C. of the hard contact lens 10, the size of the edge portion E, and the diameter D.

In the composition mixing step (S30), which is the step of mixing a composition for printing an iris design on the hard contact lens 10, an oligomer, which has fluororesin as its main ingredient, and a pigment are mixed at a suitable mixing ratio so that an iris design can be properly adhered onto the hard contact lens 10, which is formed into a predetermined shape, and cannot be deformed on the hard contact lens 10, unlike on a soft contact lens where it would be easily deformable.

In the printing step (S40), which is the step of mounting the hard contact lens 10 on the centering jig 20 and printing an iris design on the outer circumference of the front surface of the hard contact lens 10 using a composition for printing, a composition for printing contained in a cup 30 mounted in a printing apparatus is fed to a copper plate 40 and is then printed on the outer circumference of the front surface of the hard contact lens 10, which is mounted manually on the centering jig 20, by using a printing head 50.

In the cup 30, the composition for printing is contained. Preferably, a number of cups 30 determined by the number of color patterns of an iris design may be mounted in the printing apparatus.

Preferably, the size of the copper plate 40 may be determined by the size of the hard contact lens 10, and a number of copper plates 40 determined by the number of color patterns of an iris design may be mounted in the printing apparatus.

Particularly, in the case of a colored soft contact lens, the diameter of a soft contact lens and the diameter of an iris design both increase when the soft contact lens is hydrated in the process of fabricating the colored soft contact lens, and thus, a copper plate having a smaller size than the actual iris design is used. On the other hand, since the diameter of a hard contact lens does not change in the process of fabricating a colored hard contact lens, a copper plate having the same size as an iris design may preferably be used.

The post-treatment step, which is the step of performing post-treatment to prevent damage to the composition for printing of the hard contact lens with the iris design printed thereon, includes a coating step (S50) and a curing step (S60).

In the coating step (S50), which is the step of coating the hard contact lens with the iris design printed thereon, the front surface of the hard contact lens is coated with a coating liquid so as for the iris design printed on the outer circumference of the front surface of the hard contact lens to remain its printed state.

In the curing step (S60), which is the step of thermally curing the composition for printing of the hard contact lens with the iris design printed thereon and the coating liquid so as to fix them on the hard contact lens, the hard contact lens with the iris design printed thereon may preferably be thermally cured at a temperature of 35 to 45□ for 20 to 28 hours. Specifically, for an optimal curing, thermal curing may be performed at a temperature of 40□ for 24 hours. The curing temperature is limited for the following reasons: if the curing temperature is lower than 35° C., the composition for printing may not be properly cured thermally on the hard contact lens, and as a result, the adherence of the composition for printing may be degraded; and if the curing temperature is higher than 45° C., the hard contact lens and the composition for printing may be thermally damaged or the physical properties of the hard contact lens and the composition for printing may be deformed due to high temperature. The curing time is limited for the following reasons: if the curing time is shorter than 20 hours, the composition for printing may not be properly cured thermally on the hard contact lens, and as a result, the fixing property of the composition for printing may be degraded; and if the curing time is longer than 28 hours, the thermal curing efficiency may be degraded due to a prolonged thermal curing.

As discussed above, a hard contact lens having iris designs of various colors and patterns can be fabricated by printing iris designs of various colors and patterns on the outer circumference of the front surface of a hard contact lens with the use of a composition for printing.

Also, in a preparation step, since a hard contact lens is processed, a centering jig is fabricated, and a composition for printing is mixed, a hard contact lens can be processed to have a size suited for a user, a centering jig can be fabricated to have a size suited for the hard contact lens, and a composition capable of maintaining its adherence on the hard contact lens can be prepared.

Also, in a jig fabrication step, since a centering jig is fabricated in accordance with the inner curvature radius of a hard contact lens, the size of an edge portion of the hard contact lens, and the diameter of the hard contact lens, the amount of time that it takes to perform centering between the hard contact lens and the centering jig can be reduced, and at the same time, the bonding between the hard contact lens and the centering jig can be improved.

Also, in a composition mixing step, since an oligomer, which has fluororesin as its main ingredient, and a pigment are mixed. As a result, the adherence of an iris design on a hard contact lens, which is formed into a predetermined shape, can be improved so that the iris design can be properly adhered on the hard contact lens and cannot be deformed on the hard contact lens, unlike on a soft contact lens where it would be easily deformable.

Also, in a printing step, since a composition for printing contained in a cup mounted in a printing apparatus is fed to a copper plate and is then printed on a hard contact lens, iris designs of various colors and patterns can be printed on the hard contact lens with ease.

Also, since a composition for printing is contained in each cup and a number of cups determined by the number of color patterns of an iris design are mounted in a printing apparatus, iris designs of various colors and patterns can be realized on the outer circumference of the front surface of a hard contact lens.

Also, since the size of each copper plate is determined by the size of each hard contact lens and a number of copper plates determined by the number of color patterns of an iris design are mounted in a printing apparatus, iris designs of various colors and patterns can be realized on the outer circumference of the front surface of a hard contact lens.

Also, in a post-treatment step, since a hard contact lens with an iris design printed thereon is coated and is then thermally cured, the adherence of an iris design printed on the outer circumference of the front surface of the hard contact lens can be improved, and the discoloration of the iris design can be prevented so as to the durability of the iris design.

Also, in a coating step, since a coating liquid is applied onto the entire front surface of a hard contact lens so as for an iris design printed on the outer circumference of the front surface of the hard contact lens to remain its printed state, damage to the iris design can be prevented, and at the same time, the retention period of the iris design can be extended.

Also, in a curing step, since a hard contact lens with an iris design printed on the outer circumference of the front surface thereof is thermally cured at a predetermined temperature, the adherence of the iris design printed on the outer circumference of the front surface of the hard contact lens can be improved.

The present invention may be embodied in other specific forms without departing from its spirit or essential characteristics. Thus, the aforementioned exemplary embodiments are merely exemplary in all respects and should not be construed as limiting.

### DESCRIPTION OF REFERENCE NUMERALS

10: Hard Contact Lens 20: Centering Jig

30: Cup 40: Copper Plate

50: Printing Head

What is claimed is:

1. A colored hard contact lens printing method for printing an iris design on a front surface of a hard contact lens, the colored hard contact lens printing method comprising:
a preparation step of preparing a hard contact lens, a centering jig, and a composition for printing so as print an iris design on the hard contact lens;
a printing step of mounting the hard contact lens on the centering jig and printing the iris design by using the composition for printing; and
a post-treatment step of post-treating the hard contact lens having the iris design printed thereon,
wherein the preparation step comprises:
a lens processing step of processing a hard contact lens;
a jig fabrication step of fabricating a centering jig to have a size suited for the processed hard contact lens; and
a composition mixing step of mixing a composition for printing an iris pattern on a hard contact lens.

2. The colored hard contact lens printing method of claim 1, wherein the jig fabrication step comprises fabricating a centering jig in accordance with an inner curvature radius of a hard contact lens, a size of an edge portion of the hard contact lens, and a diameter of the hard contact lens.

3. The colored hard contact lens printing method of claim 1, wherein the composition mixing step comprises mixing an oligomer, which has fluororesin as its main ingredient, and a pigment.

4. The colored hard contact lens printing method of claim 1, wherein the printing step comprises feeding the composition for printing, contained in a cup mounted in a printing apparatus, to a copper plate and printing the fed composition on the hard contact lens mounted on the centering jig.

5. The colored hard contact lens printing method of claim 4, wherein the cup contains the composition for printing therein and a number of cups determined by a number of color patterns of the iris design are mounted in the printing apparatus.

6. The colored hard contact lens printing method of claim 4, wherein a size of the copper plate is determined by a size of the hard contact lens and a number of copper plates determined by a number of color patterns of the iris design are mounted in the printing apparatus.

7. The colored hard contact lens printing method of claim 1, wherein the post-treatment step comprises:
a coating step of coating the hard contact lens with the iris design printed thereon; and
a curing step of thermally curing the coated hard contact lens.

8. The colored hard contact lens printing method of claim 7, wherein the coating step comprises applying a coating liquid onto the front surface of the hard contact lens so as for the iris design to remain its printed state on the front surface of the hard contact lens.

9. The colored hard contact lens printing method of claim 7, wherein the curing step comprises thermally curing the hard contact lens at a temperature of 35° to 45° for 20 to 28 hours.
